(19) United States
(12) Patent Application Publication
(10) Pub. No.: US 2026/0222222 A1
(43) Pub. Date: Jul. 30, 2026

(54) Method, device and system for checking the validity of a message

(71) Applicant: ORANGE, Issy-les-Moulineaux (FR)

(72) Inventors: Benoit RADIER, CHATILLON (FR); Olivier LE GRAND, CHATILLON (FR); Gaël FROMENTOUX, CHATILLON (FR); Arnaud BRAUD, CHATILLON (FR); Xavier MARJOU, CHATILLON (FR)

(21) Appl. No.: 19/107,884

(22) PCT Filed: Aug. 30, 2023
(86) PCT No.: PCT/EP2023/073834

§ 371 Date: Feb. 28, 2025

(30) Foreign Application Priority Data
Sep. 1, 2022 (FR) FR2208800

(51) Int. Cl. H04L 9/32

(52) U.S. Cl. CPC H04L 9/3247

(57) ABSTRACT

A method, a device and a system for checking the validity of a message transmitted by a first function to a second function, the two functions contributing to instantiating a service in a communication network. The method is implemented in the second function, able to analyze a message having a signed digital credential, the signed credential including an identifier of a certification register of the communication network, an identifier of a certification entity and a validity parameter of a characteristic relating to the service of the first function. The method includes: receiving the message having the signed digital credential associated with the characteristic of the first function relating to the service; obtaining a decryption datum from the certification register determined based on the received identifier; and determining the validity of the received message.

### 1. TECHNICAL FIELD

The invention is implemented in a data infrastructure, with this infrastructure possibly being instantiated by a plurality of participants involved in the provision of a communication service. More specifically, the aim of the invention is that a function (or module or device) of the infrastructure receiving a message from another function can ensure the conformity of the message, and subsequently of the transmitting function, with a set of requirements specific to the infrastructure and to the communication service.

### 2. PRIOR ART

According to known techniques, the data infrastructures are known and notably allow a client to be provided with a service by relying on the contribution of one or more participants sharing resources, such as functions (equipment, modules). Providing the service involves the participants providing data that is useful for the provision of services. Furthermore, the communication networks increasingly rely on functions, including virtualized functions, that are possibly administered by distinct participants. Thus, for example, in fifth generation communication networks, the initially defined network or value added functions, such as unitary functions, for example, implemented in specific equipment, are increasingly implemented by interconnecting elementary functions forming a unitary function. Consequently, a network function is increasingly in the form of a set of interconnected elementary functions communicating with each other. These elementary functions are also possibly managed by distinct entities. Thus, the network data analytics function, NWDAF, which notably allows data to be collected that relates to a user, to a network function, or to a maintenance and management function, can be implemented based on distributed software functions. The NWDAF function interacts with various entities of a communication network, such as AMF (Access and Mobility Function), SMF (Session Management Function), PCF (Policy Control Function), UDM (Unified Data Management) and AF (Application Function) entities. This NWDAF entity, when structured as several elementary functions, also requires exchanges of messages between these elementary functions. Thus, as described in 3GPP documents TS 29.520, version 17, September 2020, and TS 23.288, version 17. March 2021, the NWDAF function can be divided into an AnLF (Analytics Logical Function) function responsible for analyzing and inferring data and providing statistics and an MTLF Model Training Logical Function) function responsible for instantiating and training new training models for data analysis. Furthermore, notably when the source of the data and the entity responsible for using an analysis result are not managed by the same participant, then the analysis data is transmitted between the functions via an NEF (Network Exposure Function) function. The elementary functions of an NWDAF can also interact with a DCCF (Data Collection and Coordination Function) function responsible for collecting data and coordinating data recipients, for example when several functions require the same data or when several NWDAF entities, possibly made up of distributed elementary functions, are deployed in a communication network.

In addition to the example of an NWDAF function requiring an exchange of messages between several functions of a communication network, it should be noted that the mobile network access analysis functions of the SON (Self Organizing Network) type, the mobile network data analysis management MDAF (Management Data Analytic Function) functions, the services for analyzing the information collected on terminals of the mobile network by DCAF (Data Collection AF) functions can be implemented based on elementary functions or modules requiring exchanges of messages between the modules and with other entities of a communication network, such as the function or functions forming an NWDAF function. Services based on storing and processing access data (which is known as Edge Computing) represent another environment requiring exchanges between possible entities managed by distinct participants. Thus, an Edge Computing environment notably comprises EAS (Edge Application Server), EES (Edge Enabler Server). ECS (Edge Configuration Server) Cloud functions and Cloud clients in the EEC (Edge Enabler Client) terminal and ACs (Application Clients).

However, these exchanges of messages notably generated by the distribution of elementary functions possibly managed by various participants, according to the prior art, are not likely to comply with specifications common to a data space and/or to a communication network, or are even not likely to comply with security requirements issued by a regulator and/or a manager of the communication network. It is not possible, according to the techniques that are currently used, for a function receiving a message from another function to ensure that the received message complies with one or more requirements of the communication network and/or of a service whose data is routed or processed by the functions.

The aim of the present invention is to provide improvements over the prior art.

### 3. DISCLOSURE OF THE INVENTION

The invention improves the situation using a method for checking the validity of a message transmitted by a first function to a second function, with the two functions contributing to the instantiation of a service in a communication network, the method being implemented in the second function that is able to analyze a message comprising a signed digital credential, the signed credential comprising an identifier of a certification register of the communication network, an identifier of a certification entity and a validity parameter of a feature of the first function relating to the service, and comprising:
receiving the message comprising the signed digital credential associated with the feature of the first function relating to the service;
acquiring a decryption datum from the certification register determined based on the received identifier, said decryption datum being associated with the identifier of the certification entity;
determining the validity of the received message comprising:
verifying the signature and the integrity of the digital credential signed by the certification entity using the acquired decryption datum;
comparing the validity parameter of the signed digital credential with a required value associated with the at least one feature.

A function of a communication network, which also can be called a virtualized module, equipment or instance, can help to provide a service in a communication network, such as an application service intended for a user or a network service, if it complies with one or more requirements specific to the service in general, and therefore also to the communication network, or even to the user. Thus, the function must acquire a signed digital credential from a certification entity, which credential also can be referred to as a certificate, proof or even token, associated with a feature of the function, ensuring that the feature is properly approved by a certification entity and that the function can actually contribute to the service. A function can require the approval of several features from one or more certification entities. Knowing that the other functions, with which the function exchanges messages in order to implement the service, have no information concerning whether or not the approval has been received, the method allows them to be notified as such and allows them to actually verify that the function that sent them a data message relating to the service has indeed acquired one or more certifications or approvals for all the features requiring such certification. The method is notably useful when the functions are managed by distinct participants and when the functions do not have other a nriori means for indicating their respective certifications. Thus, the two functions can exchange signed digital credentials via a file attached to a data message related to the service, and the receiving function can verify this approval by comparing the data in the file with reference values and by verifying the signature of the credential by means of a decryption datum acquired from a register managing the decryption data of the features. This datum is used to verify the signature, the fact that the credential has not been modified and that values, for example binary elements or a sequence of digits, concerning the feature comply with values that are required in order for the message received from the first function, and then the function, to be validated. The receiving function, which is identified as the second function, must be able to unambiguously determine that a signed digital credential associated with a feature received from another function, namely the transmitting function or the first function, is intrinsically linked to a certification of the feature by a certification entity of the communication network. The validity of the signature and the values of the signed digital credential involves the validity of the message comprising the signed digital credential, given that the signed digital credential provides the receiving function with information concerning the certification of features of the transmitting function. The validity of the message transmitted by the first function also allows the first function to be validated by the second function. For a service developed by sequencing functions, validating the messages one at a time by the functions allows the sequence, the functions involved, and therefore subsequently the implemented service to be validated.

According to one aspect of the invention, in the checking method, the two functions are elementary modules of a device of the communication network.

The method is particularly advantageous within a context where both functions form two elements of a device or equipment. Notably, if the two modules are virtualized functions and they are possibly administered by distinct managers, the method ensures that each module complies with a set of security, quality of service, location requirements, etc., and that the service implemented by the various modules corresponds to a service implemented by a corresponding physical device or equipment, comprising the various modules within the same physical entity.

According to another aspect of the invention, in the checking method, the validity parameter of a feature is one or more parameters from among the following parameters:
a maximum validity date of the signed credential;
a non-revocation parameter of the signed digital credential;
an identifier of the feature.

Advantageously, the validity parameter of the signed digital credential can include a maximum validity date of the signed digital credential and the first function by comparing the maximum date and the reception date in order to consider whether or not the received message is valid. The parameter also can be non-revocation information represented by a binary element. By comparing this binary element with a reference value, the second function can determine whether or not the credential is valid. The identifier of the feature, compared, for example, with an identifier acquired from a management entity, can be used to detect, for example, identity theft and not to validate the message if these identifiers do not match, for example.

According to another aspect of the invention, in the checking method, the decryption datum is a public decryption key associated with a private encryption key relating to the certification entity.

The digital credential can be signed with an encryption key associated with the certification entity that certified the feature corresponding to the signed digital credential. Thus, according to one example, the signed digital credential can be a hash encrypted with a private encryption key. The second function, using for example, a public key associated with the private encryption key, can decrypt the hash and then determine whether the decrypted hash has the same value as the hash computed by the second function and thereby verify the signature and the integrity of the credential.

According to another aspect of the invention, in the checking method, determining the validity of the datum further comprises revoking the first function in case the signature and the integrity of the signed digital credential are not verified and/or the validity parameter of the signed digital credential is not equivalent to the required value.

In the event that the signature of the signed digital credential cannot be verified, because the value of the decrypted hash does not correspond to a value computed by the second function, and/or if the integrity of the received message is not complied with and/or one of the values of the credential does not correspond to an expected value, the message is not validated. This can be due to a revoked certificate or even because the first function transmitting the message is not the one it indicates to be, and that a function has, for example, stolen the identity of another function. If one or more features of the first function cannot be certified, then it is revoked and the exchanges of messages with this function are interrupted.

According to another aspect of the invention, in the checking method, said signed digital credential comprises location information of a revocation register, with said revocation register being able to store validity information relating to a feature of the first function. The signed digital credential can advantageously include location information, such as an IP address or a DNS name, of a revocation register, thereby allowing the second function to be able to invoke this register if a datum is still valid or if a certificate acquired by the first function from the certification entity is still valid and thus have updated information concerning the ability of the first function to continue sending and receiving messages associated with the service. The second function can also use this information to notify the revocation register of an invalid signed digital credential and subsequently of a certification of a feature to be renewed.

According to another aspect of the invention, in the checking method, the feature related to the service of the first function is one or more of the following features:
a security feature of the first function;
a conformity feature of the message with a data format of a specific function of the communication network:
a location feature of the first function;
a consent feature of a user of the service for using a datum relating to a user of the service, included in the message;
a conformity feature of the first function with a rule determined by a regulation entity of the communication network:
a feature of identifying a legal entity responsible for the first function.

In order for a function to comply with a service, a communication network, a user or a data space comprising a plurality of functions, this possibly must comply with a set of features. The certification entity responsible for assigning a certificate for a feature can be specific or even responsible for the certification of a plurality of features. In the latter case, the certification entity assigns respective certificates for a set of distinct features. The features can be imposed by a requirement of a user of the service, an external entity responsible, for example, for verifying the security for implementing the service, a body for verifying the formats of the messages, a participant or an operator responsible for managing the communication network and/or for providing the service.

According to another aspect of the invention, in the checking method, said determination of the validity comprises transmitting the signed digital credential and an identifier of the first function to the certification register, and receiving, following this transmission, the decryption datum associated with the certification entity.

The determination can advantageously include an exchange of messages between the second function and the certification register, allowing the second function to receive, subject to an explicit request, a decryption datum associated with the certification entity that certified the feature and possibly specific to the feature.

The various aspects of the checking method that have been described above can be implemented independently of each other or in combination with each other.

The invention also relates to a method for transmitting a message by a first function to a second function, with the two functions contributing to the instantiation of a service in a communication network, the method being implemented in the first function that is able to attach a signed digital credential to the message to be transmitted to the second function, the signed credential comprising an identifier of a certification register of the communication network, an identifier of a certification entity and a validity parameter of a feature of the first function relating to the service, and comprising:
acquiring the signed digital credential from the certification entity;
adding the acquired signed digital credential to the message relating to the service to be transmitted to a second function;
transmitting the message including the added signed digital credential to the second function.

According to one aspect of the invention, the transmission method further comprises transmitting a certification request to the certification entity requesting the certification of the feature and the acquired signed digital credential includes certification information generated based on an encryption datum associated with the certification entity.

The invention also relates to a device for checking the validity of a message transmitted by a first function to a second function, with the two functions contributing to the instantiation of a service in a communication network, the device instantiated in the second function being able to analyze a message comprising a signed digital credential, the signed credential comprising an identifier of a certification register of the communication network, an identifier of a certification entity and a validity parameter of a feature of the first function relating to the service, and comprising:
a receiver able to receive the message comprising the signed digital credential associated with the feature of the first function relating to the service;
an acquisition module able to acquire a decryption datum from the certification register determined based on the received identifier, said decryption datum being associated with the identifier of the certification entity;
a determination module able to determine the validity of the received message comprising:
a verification module able to verify the signature and the integrity of the digital credential signed by the certification entity using the acquired decryption datum and the identifier of the received certification entity;
a comparator able to compare the validity parameter of the signed digital credential with a required value associated with the at least one feature.

This device is able to implement the checking method described above in all the embodiments thereof.

The invention also relates to a device for transmitting a message by a first function to a second function, with the two functions contributing to the instantiation of a service in a communication network, the device implemented in the first function being able to attach a signed digital credential to the message to be transmitted to the second function, the signed credential comprising an identifier of a certification register of the communication network, an identifier of a certification entity and a validity parameter of a feature of the first function relating to the service, and comprising:
an acquisition module able to acquire the signed digital credential from the certification entity:
an addition module able to add the acquired signed digital credential to the message relating to the service to be transmitted to a second function;
a transmitter able to transmit the message including the added signed digital credential to the second function.

This transmission device is able to implement the transmission method described above in all the embodiments thereof.

The invention also relates to a system for checking the validity of a message transmitted by a first function to a second function, with the two functions contributing to the instantiation of a service in a communication network, comprising:
a checking device;
a transmission device.

The invention also relates to computer programs comprising instructions for implementing the steps of the respective checking and transmission methods described above, when these programs are both executed by a processor, and a storage medium, respectively readable by a checking device and a transmission device on which the computer programs are stored.

The aforementioned programs can use any programming language, and can be in the form of source code, object code, or of intermediate code between source code and object code, such as in a partially compiled format, or in any other desirable format.

The aforementioned information media can be any entity or device capable of storing the program. For example, a medium can comprise a storage means, such as a ROM, for example a CD-ROM or a microelectronic circuit ROM, or even a magnetic storage means.

Such storage means can be, for example, a hard disk, a flash memory, etc.

Moreover, an information medium can be a transmissible medium such as an electrical or optical signal, which can be routed via an electrical or optical cable, via radio, or via other means. A program according to the invention particularly can be downloaded over a network of the Internet type.

Alternatively, an information medium can be an integrated circuit, in which a program is incorporated, with the circuit being adapted to execute or to be used to execute the methods in question.

### 4. BRIEF DESCRIPTION OF THE DRAWINGS

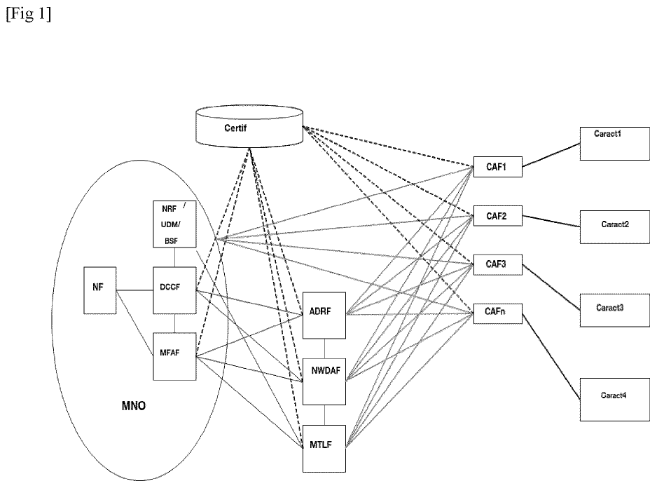

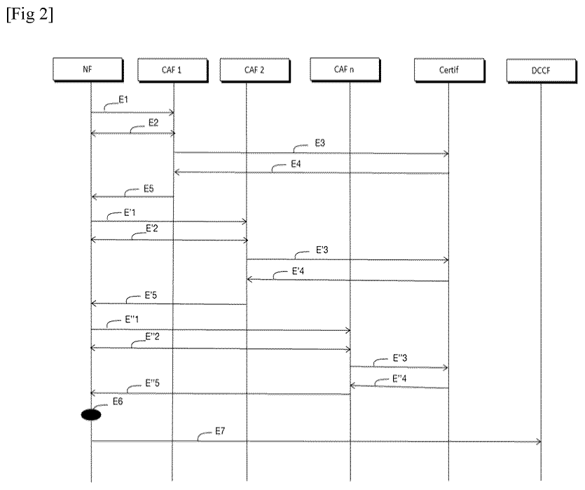

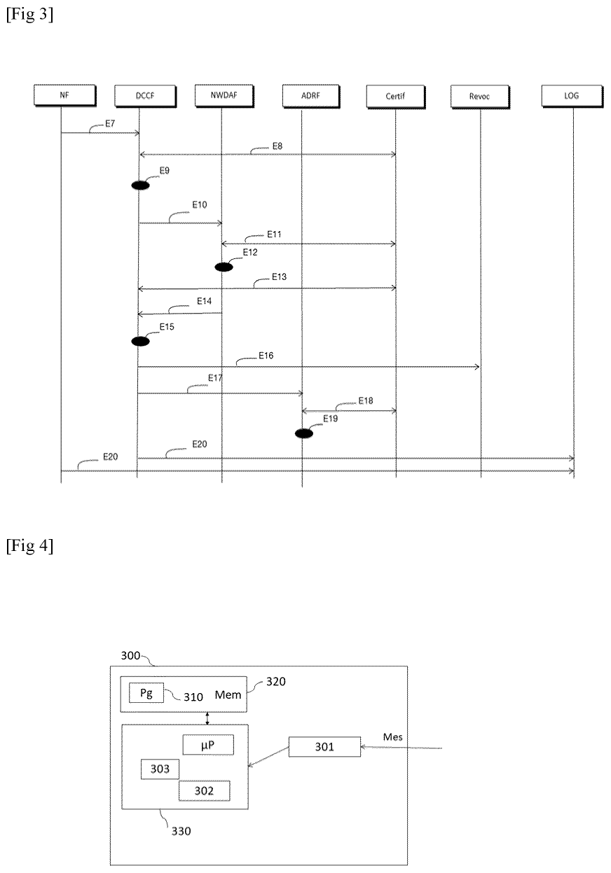

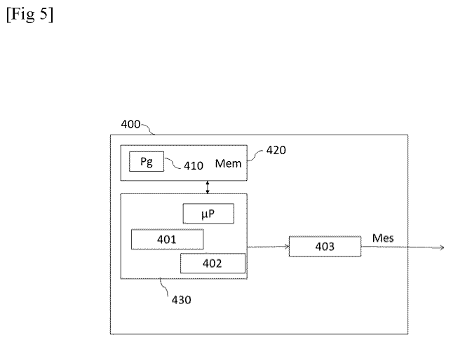

Further features and advantages of the invention will become more clearly apparent upon reading the following description of particular embodiments, which are provided by way of simple illustrative and non-limiting examples, and the appended drawings, in which:

[FIG. 1], according to one aspect of the invention, describes a communication network in which the checking method and the transmission method are instantiated;

[FIG. 2] describes the implementation of the transmission method in a communication network according to one embodiment of the invention;

[FIG. 3] describes the implementation of the checking method according to one embodiment of the invention;

[FIG. 4] describes a checking device according to one embodiment of the invention;

[FIG. 5] describes a transmission device according to one embodiment of the invention.

### 5. DESCRIPTION OF THE EMBODIMENTS

Throughout the remainder of the description, embodiments of the invention are presented in a communication network. This network can be implemented in order to route communication data to fixed or mobile terminals and the network can be implemented from physical equipment and/or virtualized functions. This network can be used for routing and/or processing residential or business client data.

Reference is initially made to [FIG. 1], which shows a communication network in which the checking method and the transmission method are instantiated. The functions implemented by a mobile communications network operator (MNO) are as follows:
An NF (Network Function) function, which can be any function of the mobile communication network providing routing, processing or management of data of the mobile network, for example from or to a user of the mobile network. The NF function is, for example, a virtual function providing a routing, security, filtering function or even an application function in the mobile network. These functions can, for example, transmit data specific to a communication service to analytics functions, such as the DCCF and NWDAF functions described hereafter. A single NF function is shown, but the MNO network can include multiple NF functions.
The DCCF (Data Collection Coordination Function) function subscribes to the UDM/NRF/BSF (described hereafter) in order to be notified of context information associated with a data stream for authorizing the analysis and/or the collection of data associated with a user (such as GDPR consent). This DCCF function collects and distributes data required by an NF function “consumer”. This function avoids multiple subscriptions of functions for identical data and the sending of notifications containing the same information.
UDM (Unified Data Management), NRF (Network Repository Function) and BSF (Binding Support Function) functions are respective user management, NF function management and session management functions in a mobile communications network.
The MFAF (Messaging Framework Adaptor Function) function applies the transfer policy defined by the DCCF. According to one example, the data consumers and the data sources exchange data via the MFAF function.

The communications network further comprises the following functions:
An NWDAF (Network Data Analytics Function) function collects the data of various functions, analyzes the collected data in order to propose adaptations of the functions for the services implemented on a communications network.
An ADRF (Analytics Data Repository Function) function is responsible for storing the collected data. It should be noted that the function can be divided into two functions, namely the MTLF function described hereafter and the AnLF (Analytical Logical Function) function, not shown in [FIG. 1]. This AnLF function is responsible for inferring a model, deriving data analytics therefrom and disclosing these analytics to any requestors of these analytics.
An MTLF (Model Training Logical Function) function responsible for training a model and providing new training methods.
The communications network further comprises certification entities CAF1, CAF2, CAF3, CAFn responsible for certifying features of the various functions cited above. Several certification entities are possibly deployed to certify a plurality of features of the functions. According to the example of [FIG. 1], each certification entity certifies a feature and the entities CAF, CAF2, CAF3, CAFn certify the respective features Caract1, Caract2, Caract3, Caract4 associated with a communication service, with the service being able to be an application service or a network service. The features can correspond to security, location, rule conformity features determined by a regulation entity, the consent of a user to use data from the messages transmitted or received by this user, conformity with the GDPR (General Data Protection Regulation) conditions, data storage conditions, etc. The entities CAF1, CAF2, CAF3, CAFn can be managed by various entities and an entity can certify a plurality of features. Thus, each function of the network, as mentioned above, is certified with one or more certification entities CAF1, CAF2, CAF3 and CAFn when the function comprises one or more of the features Caract1, Caract2, Caract3, Caract4. This certification is especially important when the functions are managed by various participants and when they help to route data in a data space, in which a plurality of participants possibly helps to provide functions. Thus, each participant, which equally can be an operator or a service provider or a regulation entity, is guaranteed that the functions involved in routing data associated with a service comply with a certain r number of constraints and obligations. When a certification entity CAF1, CAF2, CAF3 and CAFn certifies a feature Caract1, Caract2, Caract3, Caract4 for a function from among the NF, DCCF, MFAF, NRF, UDM, BSF, ADRF, NWDAF, MTLF, AnLF functions for a given service, after invoking said function, the certification entity sends the function a signed digital credential associated with the feature for the service in question. Some features, notably security features or even the consent of a user, can be service specific, while some are more generic and can be common for a plurality of services. The transmitting function, once it has acquired the various signed digital credentials, for example by means of a private encryption key, associated with the service, will be able to join them to the messages exchanged with the other functions so that the functions receiving the messages can check the validity of the received message. The message received by a receiving function can be a checking message and can correspond to a message exchanged between functions of a “disaggregated” device, with said functions preferably being virtualized.
The communications network further comprises a certificates register Certif, such as decryption data, associated with the features, with the register being updated by the various certification entities CAF1, CAF2, CAF3 and CAFn, allowing a feature to be certified for a function or its certification to be updated. The register Certif contains the updated certificates and ensures that the updated certificates are available so that it is possible to determine the effective certifications of the various features of functions contributing to a service in the communication network. A certification register Certif and a certification entity CAFn are distinct entities. The register Certif includes the decryption data used to verify a signature of a signed digital credential assigned by the certification entity CAFn to a function in a communication network.

The signed digital credential transmitted by one function to another function can correspond to a certificate as held by the register Certif or even the signed digital credential can be related to a certificate, i.e. the certificate can be used to help to verify the received message, by verifying the signature of the digital credential and the integrity of the signed digital credential.

Reference will now be made to [FIG. 2], which describes the implementation of the transmission method in a communication network according to one embodiment of the invention.

In this embodiment, the NF entity, which can be any type of function of a communication network, interacts and sends/receives messages of other functions of the communication network. According to another example, the NF function can be replaced by a function of a disaggregated NWDAF, such as an AnLF function or an MTLF function, or it even can be replaced by any function described in [FIG. 1].

The NF function, in order to be able to be integrated into the communication network and interact with the other functions of this network, must be certified, i.e. various features of the function must be verified as a function of a service to be implemented in the communication network. Some features of the function are independent of this service, while some of them relate to the service to be instantiated. Thus, by way of an example, the location of the function is most often independent of the service, while a data format is related to the service to be instantiated. A feature is considered to relate to a service even if the same feature can be common to several services. The service can be a service for checking the communication network or even a value added service (voice, text, video).

In order to be able to be certified for a service, the NF function invokes, before the implementation of the service, a certification entity responsible for certifying that a feature of the NF function is compatible with the service and the communication network. Knowing that a plurality of features possibly need to be certified, the NF function invokes one or more certification entities respectively associated with distinct features. Thus, the NF function invokes the entities CAF, CAF2, CAF3 and CAFn to certify four features required for the implementation of a service. The certification entities CAF1, CAF2, CAF3 and CAFn can be managed by one or more participants. One certification entity can be managed, for example, by a regulation entity and another can be managed by a security auditor. This certification is particularly useful when the functions likely to exchange messages are themselves managed by distinct participants and each participant must ensure conformity of the functions of the other participants. During a step E1, the NF function, which according to this example is a disaggregated function of an NWDAF function, transmits a certification request message of a location feature to the entity CAF1. The certification request message includes information relating to the location of the NF function, and possibly a service identifier, and, in response to this request, the entity CAF1 performs an audit, during a step E2, to ensure that the location indicated by the NF function is indeed that indicated in the certification request. This audit can include transmitting and receiving multiple messages between the NF function and the entity CAF1. When the audit determines that the location of the NF function is validated and corresponds to a parameter of the service to be instantiated, then the entity CAFR certifies the feature and transmits a certificate, which is required in order to confirm the conformity of this location feature, to a certification register Certif during a step E3. The certificate transmitted to the register Certif can correspond to a token and/or to a public decryption key corresponding to a private key associated with the entity C AFI and possibly with the feature. This certificate then allows a signed digital credential to be confirmed, comprising one or more parameters relating to a feature, transmitted by one function to another function when exchanging messages relating to a communication service for which one or more features are certified. According to another example, the certificate stored in the register Certif corresponds to a public certificate containing a public security key.

According to one example, the certificate is as indicated below:

```
Token:
{
  ″@context″: [
    ″https://www.w3.org/2018/credentials/v1″,
    ″https://www.w3.org/2018/credentials/examples/v1″
  ],
  ″id″: ″http://example.edu/credentials/3732″,
  ″type″: [″VerifiableCredential″, ″UniversityDegreeCredential″],
  ″issuer″: ″https://example.edu/issuers/14″,
  ″issuanceDate″: ″2010-01-01T19:23:24Z″,
  ″credentialSubject″: {
    ″id″: ″did:example:ebfeb1f712ebc6f1c276e12ec21″,
    ″degree″: {
      ″type″: ″BachelorDegree″,
      ″name″: ″Bachelor of Science and Arts″
    }
  },
The token contains:
  - The address where the certificate is stored ″id″:
    ″http://example.edu/credentials/3732″,
  - The type of certificate: [″VerifiableCredential″,
  - The address of the entity of the certifier: ″issuer″:
    ″https://example.edu/issuers/14″,
  - When it was issued: ″issuanceDate″: ″2010-01-01T19:23:24Z″,
  - With the address where the certificate is stored being used to prove
    the subject of the certificate, in this case bachelor degree ″type″:
    ″BachelorDegree″, ″name″: ″Bachelor of Science and Arts″
```

In [FIG. 2], a single register Certif is described but several certification registers can be provided, for example associated with distinct certification entities.

During a step E4, the certification register Certif confirms, with the entity CAF1, the correct reception and registration of the certificate received from said entity CAF1 by sending back an acknowledgement message.

During a step E5, the entity CAF1 sends the NF function the signed digital credential of the certified feature. This signed digital credential comprises an identifier of the certification register Certif, a identifier of the certification entity CAF1 and one or more validity parameters of the location feature, with the signed digital credential being signed with an encryption datum specific to the certification entity CAF1 and possibly to the location feature.

Correspondingly, the NF function certifies a security-related feature for the service to be instantiated with the certification entity CAF2, during steps E′1 to E′5 corresponding to the previously cited steps E1 to E5. According to an alternative, the entity CAF2 and the entity CAF1 are a single entity. The entity CAF2 is managed by a participant other than that managing the entity CAF1 and aims to ensure that the NF function complies with security constraints, for example in terms of supported security protocols and/or conformity with confidentiality constraints. If the NF function complies with the security conditions as prescribed by the entity CAF2, in accordance with requirements of the communication network in which the NF function is deployed and/or a contract signed with other participants for the instantiation of the service, it acquires the signed digital credential relating to the security feature.

Correspondingly, the NF function requests certification, during steps E″1 to E″5, corresponding to steps E1 to E5, of a feature relating to compatibility with a specification of the communication network in which the service is to be instantiated. According to one example, the NF function acquires a certification from the entity CAFn confirming the compatibility of the NF function with a 3GPP specification, Release 17. The entity CAFn in this example is an entity managed by a body different from the entity administering the NF function. The NF function thus acquires, during step E″5, a signed digital credential associated with the 3GPP specification, Release 17, from the certification entity CAFn. Once the NF function has received all the signed digital credentials associated with a service to be instantiated in the communication network, it adds, during a step E6, these various signed digital credentials to a conformity document consolidating all the received signed digital credentials. If a single signed digital credential is acquired, the conformity document corresponds to the received signed digital credential.

### EXAMPLE OF A CONFORMITY DOCUMENT

```
{
  ″@context″: [
    ″https://www.w3.org/2018/credentials/v1″,
    ″https://www.w3.org/2018/credentials/examples/v1″
  ],
  ″type″: ″VerifiablePresentation″,
  ″verifiableCredential″: [{
    ″@context″: [
      ″https://www.w3.org/2018/credentials/v1″,
      ″https://www.w3.org/2018/credentials/examples/v1″
    ]
    ″id″: ″http://example.edu/credentials/1872″,: address for storing the signed digital
credential
    ″type″: [″VerifiableCredential″, ″AlumniCredential″],
    ″issuer″: ″https://example.edu/issuers/565049″,
    ″issuanceDate″: ″2010-01-01T19:23:24Z″,
    ″credentialSubject″: {
      ″id″: ″did:example:ebfeb1f712ebc6f1c276e12ec21″,: address for verifying if the
feature is compliant
      ″alumniOf″: {
        ″id″: ″did:example:c276e12ec21ebfeb1f712ebc6f1″,
        ″name″: [{
          ″value″: ″Example University″,
          ″lang″: ″en″
        }, {
          ″value″: ″Exemple d'Université″,
          ″lang″: ″fr″
        }]
      }
    }
    ″proof″: {: proof of validity of the signed digital credential acquired by the function
      ″type″: ″RsaSignature2018″, : Type of encryption used for the digital credential
      ″created″: ″2017-06-18T21:19:10Z″,
      ″proofPurpose″: ″assertionMethod″,
      ″verificationMethod″: ″https://example.edu/issuers/565049#key-1″,: Address for
retrieving the encryption data from 56049 (university) for verifying the signature
            ″jws″:HeyJhbGciOiJSUzI1NiIsImI2NCI6ZmFsc2UsImNyaXQiOlsiYjY0Il19..T
            CYt5X sITJX1CxPCT8yAV-TVKIEq_PbChOMqsLfRoPsnsgw5WEuts01mq-
            pQy7UJiN5mgRxD-WUcX16dUEMGlv50aqzpqh4Qktb3rk-
            BuQy72IFLOqV0G_zS245-
            kronKb78cPN25DGlcTwLtjPAYuNzVBAh4vGHSrQyHUdBBPM″: digital
            credential signature
    }
  }],
  ″proof″: {
    ″type″: ″RsaSignature2018″,
    ″created″: ″2018-09-14T21:19:10Z″,
    ″proofPurpose″: ″authentication″,
    ″verificationMethod″: ″did:example:ebfeb1f712ebc6f1c276e12ec21#keys-1″,
    ″challenge″: ″1f44d55f-f161-4938-a659-f8026467f126″,
    'domain″: ″4jt78h47fh47″,
    'jws″:
″eyJhbGciOiJSUzI1NiIsImI2NCI6ZmFsc2UsImNyaXQiOlsiYjY0Il19..kTCYt5
            XsITJX1CxPCT8yAVTVIw5WEuts01mqQy7UJiN5mgREEMGlv50aqzpqh4Q
            q_PbChOMqsLfRoPsnsgxD-WUcX16dUOqVOG_zS245-
            kronKb78cPktb3rkBuQy72IFLN25DYuNzVBAh4vGHSrQyHUGlcTwLtjPAnK
            b78″
  } : proof signed by the function issuing the signed digital credential
}
```

During a step E7, the NF function transmits a message related to the communication service to a DCCF type function. The message corresponds, for example, to a request message to acquire a plurality of information that the DCCF will have previously collected from other functions of the communication network. The NF function adds the conformity document it will have compiled during step E6 to the request message. Thus, by virtue of this conformity document, the DCCF entity can check the conformity of the features of the NF function for all the evaluated features present in the conformity document and can determine whether the signed digital credentials are valid, if the NF function has indeed certified its features, if a signature of a signed digital credential can be verified using a certificate held by the certification register Certif. The embodiment describes an exchange of messages between any NF function and a DCCF function, but this embodiment is also valid for one or more exchanges of messages between functions of a data space, as described in [FIG. 1].

Reference will now be made to [FIG. 3], which describes the implementation of the checking method according to one embodiment of the invention.

During a step E7, corresponding to step E7 of [FIG. 2], the NF function transmits a request message, with the request message corresponding to the instantiation of a communication service, to the DCCF function in order to acquire user data, as well as data session information of the service. The request message includes the signed digital credentials as acquired in accordance with the above description of [FIG. 2].

During a step E8, the DCCF function acquires a decryption datum or decryption data from the certification register Certif, an identifier of which is possibly present in a received signed digital credential, with said decryption datum or decryption data being associated with the certification entities that certified the features, and therefore being associated with the features of the NF function whose request message it has just received. In order to perform the validity check of the message received during step E7, the DCCF function can acquire all the decryption data associated with the NF function by providing the register Certif with an identifier of the NF function (DNS name, Uniform Resource Identifier (URI) address, IP address, decentralized identity (did), etc.), as well as an identifier of the certification entity that certified a feature, with this identifier being present in the received signed credentials. In the event that the decryption datum is specific to the NF function, in addition to the identifier of the entity that certified a feature, an identifier of the function also can be transmitted and if a decryption datum is associated with a service, an identifier of the service associated with the NF function can be transmitted in addition to the identifier of the NF function and the identifier of the certification entity. The acquisition can be carried out through an exchange of messages between the DCCF function and the certification register Certif, with the message transmitted to the certification register comprising an identifier of the certification entity that confirmed the validity of a feature, an identifier of the NF function and possibly an identifier of the service, and in return receiving a decryption datum specific to the certification entity that certified the feature of the service corresponding to the signed digital credential and associated with the NF function, thus allowing the DCCF function to validate the received message during step E7. According to one example, the DCCF function sends the signed digital credential received from the NF function to the certification register Certif.

During a step E9, the DCCF function that acquired a decryption datum or decryption data associated with the certification entity and corresponding to the one or more features is able to determine whether the received message is valid by validating or not validating the signed digital credentials received from the NF function during step E7. In order to complete this validation, the DCCF function verifies the signature and the integrity of the signed digital credential using the decryption datum, such as a public key. According to one example, the signed digital credential includes a proof signed using encryption data, such as a private key, specific to the certification entity that previously certified the feature in accordance with the exchanges of [FIG. 2]. Using the decryption datum corresponding to the encryption key used for signing the signed digital credential and encrypting the proof, the DCCF function determines that the signature is valid if the information acquired using the decryption datum is identical to the proof received in the signed digital credential. This operation is also used to verify that the signed digital credential has not been modified and therefore that its integrity is valid. The DCCF function also compares parameters, such as parameters relating to the maximum validity date of the credential, a non-revocation parameter of the signed credential, or even an identifier of the feature, in order to validate the message. These parameters are not necessarily encrypted and can be verified by comparing them to reference values.

During a step E10, the DCCF function sends to an NW DAF function a message to acquire statistics data related to a communication service; the service can be identical to the service initiating the request message transmitted by the NF function during step E7. The service independently can be a network service, for example for implementing or modifying a connectivity service and/or an application service (video, message, voice). The message transmitted during step E10 comprises a conformity document, comprising one or more signed digital credentials, that the DCCF function previously acquired from one or more certification entities.

During a step E11, the NWDAF function acquires a public key from the certification register Certif that relates to a certification entity that certified a security feature, the service, and a security feature of the DCCF function. According to one example, the NWDAF function transmits an identifier of the DCCF function and possibly of the security service, an identifier of the certification entity that certified the feature. During step E12, according to one of the methods indicated during step E9, the NWDAF function determines that the digital credential relating to the security feature for the service, signed by the certification entity, is valid and consequently that the message received during step E10 is valid and therefore that the DCCF function is certified. This verification was possible using the public key acquired during step E11.

During step E13, subsequent to the message transmitted to the NWDA F entity during step E10, the DCCF entity receives a response message from the NWDAF entity. This message, which relates to the same service, comprises signed digital credentials related to conformity features of the NWDAF function with a 5G network and consent of a user for operating the data of the service relating thereto, in a conformity document therefore comprising two signed digital credentials associated with the two features. The signed digital credentials further comprise an address of a revocation register Revoc, able to store validity information relating to the two features of the aforementioned NWDAF function. During a step E14, the DCCF function acquires, from the certification register Certif, a set of decryption data for verifying the signed digital credentials relating to the NWDAF function, with this data relating to certification entities for conformity to a 5G network and consent of the user whose identifiers were present in the signed digital credentials, and to features/claims of conformity of the NWDAF function with a 5G network and consent of a user. It should be noted that the features related to the service also can be related to a location of the WDAF function, to conformity of the NWDAF function with a rule determined by a regulation entity, for example in connection with obligations for backing-up data or for the use of user data, or to an identification feature of a legal entity responsible for the NWDAF function.

During a step E15, the DCCF function determines that at least one received signed digital credential does not match a certificate presented by the NWDAF. This is explicable because the signed digital credential is no longer valid, with the validity limit date of the validity parameter being earlier than the receipt of the message of step E13, and/or that the NWDAF function is not the function it purports to be and/or that at least one signed digital credential has been modified when it was sent or processed, with this verification being carried out using a decryption datum relating to the certification entity that certified one or both of the aforementioned features, with this data being acquired during step E14. When several features have yielded several signed digital credentials, the DCCF function can evaluate the impact of the revocation of a certificate or of a signed digital credential in order to decide whether or not to validate the received message and subsequently revoke or not revoke the NWDAF function that issued several signed digital credentials. The DCCF function decides that the NWDAF function is not compliant because one or more signed digital credentials are not valid and therefore decides not to validate the received message, which could compromise the service and possibly the communications network.

In the event that a revocation register address is present in the signed digital credential, then, during an optional step E16 the DCCF function can also transmit a revocation subscription for the NWDAF function to the revocation register Revoc, thereby allowing the DCCF function to be notified in the event of the revocation of a certificate associated with the NWDAF function and thus decide to interrupt the service by blocking the exchange of messages between a function and the NWDAF function.

Optionally, in an exchange not shown in [FIG. 3], a CAF function that periodically analyzes the conformity certificates of the NF functions can notify the revocation register Revoc of the revocation of the NWDAF function, in order, for example, for the certification register Certif to update the signed digital credentials management information, for example by deleting the decryption data associated with these certificates. The register Certif can also invoke the certification entity associated with the signed credential to update the certification and subsequently the signed digital credential that it holds. Revoking the NVDAF function also induces an interruption in the communication related to the service, given that the non-certification of a function in a milltiple-participant data space can induce security issues.

During a step E17, the DCCF function managed by a telecommunications operator transmits a message relating to a data storage service of a service to an ADRF (Analytics Data Repository Function) function managed by a service provider. The message transmitted by the DCCF function can include an identifier of the entity managing the DCCF function, for example the operator of the communication network in which the DCCF function is deployed. The identifier can be deduced from the address of the DCCF function used to communicate with the ADRF function or it even can be an entity-specific identifier. Each function, managed by a distinct entity of the other function, must ensure the conformity of the other function in terms of features concerning security, location, and conformity with GDPR rules. The DCCF function adds the signed digital credentials to the service related message, which signed digital credentials are associated with the previously acquired aforementioned features of certification entities and integrate hashes (in order to allow the non-repudiable nature of the message to be verified). During a step E18, the ADRF function acquires the decryption data associated with these features and the signed digital credentials of the DCCF function from the certification register Certif
with this decryption data being in the form of public encryption keys or any other decryption parameter associated with the entities responsible for the respective certifications. The ADRF function includes the identifier of the certification entities from which it has received identifiers in the signed digital credentials and it can include the identifier of the entity managing the DCCF function, if it has received it, as well as an identifier of the DCCF function, the function it will have transmitted thereto in the mnessage transmitted during step E17, as well as possibly an identifier of the service (for example, data storage), so that the register Certif only sends it the decryption data required for the DCCF function and possibly the service. During a step E19, the ADRF function determines whether the DCCF function that sent it a message for data storage is properly certified, i.e. that all the features required for communication between the two functions and possibly specific to a data space and/or a regulator, such as a public management office, have been properly certified and that the signed digital credentials are still valid. If the ADRF function is able to decrypt the received hashes using the public keys acquired from the register Certif, that it has a guarantee that the received message has not been modified by recomputing the hash from the public key, and that the validity parameters correspond to reference values, then the signed digital credentials are considered to be valid and the DCCF function is considered to be certified. In the event that the communication between the DCCF function and the ADRF function is two-way, the DCCF function can also ensure the certification of the ADRF function by implementing steps identical to steps E17 to E19. According to this example, the ADRF function can also add an identifier of the entity managing the ADRF function, for example of the service provider.

In the various exchanges indicated above between the functions, but also between a function and the vaiious registers, it is possible to add an identifier to a message transmitted to another entity (function or register). This identifier can be one or more identifiers, including:
a proprietary identifier of the data and of the result of the analyses possibly performed by an entity other than the proprietor:
an identifier of the data storage provider that provides a service for orchestrating storage or analysis functions or virtual instances of these functions;
an identifier of the software providers that develop the models and the analytical services, involving an NWDAF function or a plurality of functions of an NWDAF function if it is divided;
an identifier of a client, for example that grants their consent for processing and analyzing data of a service relating thereto.

During a step E20, and according to one example, the NF and DCCF functions, which are involved in routing or processing the data of a service, transmit log data to a storage register LOG. This log data can be timestamped, according to one example. According to one example, the messages transmitted during step E20 are alternatively transmitted to the register LOG during each exchange of messages, once the functions have been certified, therefore following steps E9, E12. The storage register LOG thus can be used for an audit, which is especially useful when the functions, such as the NF and DCCF functions, are managed by distinct entities, with the data stored in the register LOG then being able to serve as legal evidence. The message transmitted during step E20 comprises information from among the following information:
the signed digital credential relating to a certification associated with a feature related to the service;
proof of the determination of the validity of the conformity acquired by a function;
an identifier of the function receiving the message comprising the added signed digital credential;
an identifier of the function transmitting the message comprising the signed digital credential;
timestamp information of the transaction corresponding to the transmitted message, with the message comprising the signed digital credential.

According to another embodiment, the conformity document comprising all the signed digital credentials is not systematically transmitted between the various functions of the communication network, but it is possible for a function to transmit it to a single function, for example the DCCF function, which checks the validity of a message for a set of functions. Thus, functions can delegate the validity check to a third party function in order to limit overloading signaling that is generated by adding the conformity document to the messages between the various functions. In this embodiment, the function to which the validity check is delegated must be trustworthy and must warrant the secure preliminary exchanges between the delegating functions and the proxy function, such as the DCCF function, which performs the check. The third party function will then receive the signed digital credentials of the other functions and may or may not validate them by virtue of the decryption data received from the register Certif. The third party function will inform the other functions of the validity of the signed digital credentials relating to a given function.

The checking method and the transmission method are particularly relevant in a communication network where communications devices (NWDAF, NEF (Network Exposure Function), ADRF, etc.) are managed by various entities and these functions interact with functions outside the mobile network, such as user terminals and/or application servers. The methods are thus used to certify that the exchanges comply with a contract signed between the entities, with a regulation or with a specification or even with a wish of a user. Some of these functions transmit data (or information) related to one or more communication services (audio, video, text, etc.) in messages intended for other functions responsible for processing, storing or aggregating them, for example. Knowing that the services can have specific constraints, the signed digital credentials are advantageously related to a communication service in particular or to a set of services with the same constraints. Thus, each function involved in routing this data (or information) relating to a service is able to validate or not validate the signed digital credentials transmitted by another function of the communication network. In the particular case where the signed digital credential relates to the consent of a user, and that this consent is revoked, resulting in the revocation of the function transmitting the signed digital credential, then the data relating to the user is possibly deleted and the exchange of messages between functions is interrupted as a result of the revocation.

An embodiment in a communication network where an NWDAF device is disaggregated is described hereafter:

In each request made by the following interfaces/services Nddcf, Nadrf, Nnwdaf, Nmfaf, Ndrf, Nnf, linking between functions of the disaggregated NWDAF managed by various participants, the conformity presentation document “conformitydoc” must be added to the parameters of the existing interfaces/services. The services described hereafter must add the conformitydoc to their parameter.

In order to minimize overloading of the communication network and the delays in signaling:
The Nmfaf services must not contain the conformity document;
Only exchanges in the checking plane (via the DCCF) must present it and at least the following services and their responses so that each participant can present their documents via the interfaces/services Nardf and the Nnwdaf, Nmtlf, Ndccf, Nmtlf;
The subscriptions services: StorageRequest, StorageSubscriptionRequest, Subscribe/Notify, RetrievalSubscribe);
The context exchange services Nddcf_ContextManagement (Register/Update (request/response).

Each function receiving a conformity document “conformitydoc” must verify the validity of the “token” certificates (or signed digital credentials) present in this conformity document. The validity of the messages transmitted by a function and subsequently of the function is verified with the information stored in the certification registers, and more specifically by assessing whether the evidence for the tokens of the conformity document and those computed using the public keys of the register Certif correspond, i.e. that there is a relationship between the proof of conformity and the certificate.

The proof of conformity can be related to the certificate acquired from a CAF stored in a certification register in accordance with the following options:
A first function inserts a token that corresponds to a string of characters associated with claims in which multiple information can be concatenated (an example of such data is: a certificate (which itself can be a certificate address for retrieving a public key from a register), an expiry date, a CAF address (a certification entity), a signature (hash information). The proof of conformity is, for example, the hash information or the token.
The first function performs an operation computing a checksum on a message to be sent and then encrypts this checksum via a private key of A (which yields an encrypted hash-A inserted into the token)
The second function, receiving the token and seeking to ensure the validity of a message sent by the first function, performs the following operations:
   The second function also computes the hash information of the received message, which yields a hash-B;
   The second function decrypts the received encrypted hash-A by virtue of the public key of A corresponding to or included in the certificate received from the certification register and com-pares this decrypted hash-A with the hash-B value that it has just computed.
   In this case, the certificate acquired from the register relates to the received token since the public address ensures the equality of the decrypted hash-A and of the hash-B, and therefore the validity of the received message as regards the signature and the integrity of the token.

If the verification of a certificate fails, then the “conformitydoc” is rejected and the exchange of messages service between the functions cannot be performed.

According to another embodiment, the checking and transmission methods can be implemented in a Self Organizing Network (SON) mobile access communication network where the functions exchange messages related to a self-configuration and self-operating service of the access network.

According to yet another embodiment, the checking and transmission methods can be implemented between terminals and an information collection function on these terminals.

According to yet another embodiment, the checking and transmission methods can be implemented in an Edge Computing type communication network, for example by adding the conformity document to the APIs conveying the profiles of the EAS (Edge Application Server), EES (Edge Enabler Server), ECS (Edge Configuration Server) Clouds and Cloud clients in the EEC (Edge Enabler Client) terminal and the ACs (Apmlication Clients). The conformity document also can be added to the descriptions of contexts associated with storage space providers (clouds) that are used by a mobile network, for example to apply the local policies and regulations to the storage spaces.

The checking and transmission methods can be implemented in a communication architecture comprising several chained functions where each function of the sequence can check the validity of a message transmitted by one of the nodes of the chain and received by the node verifying the validity by virtue of the signed digital credentials present in the conformity document accompanying the message.

Reference will now be made to [FIG. 4], which shows a device 300 for checking the validity of a message according to one embodiment of the invention.

Such a checking device can be implemented in a network function or application or in an elementary module of a device of a communication network, such as a 5G network.

According to an alternative, the checking device can be instantiated in a communication terminal, such as a mobile terminal or access equipment for a fixed network.

For example, the checking device 300 comprises a processing unit 330, equipped, for example, with a microprocessor μP, and driven by a computer program 310, stored in a memory 320 and implementing the checking method according to the invention. On initialization, the code instructions of the computer program 310 are loaded, for example, into a RAM, before being executed by the processor of the processing unit 330. Such a checking device 300 comprises:
a receiver (301) able to receive the message (Mes) comprising the signed digital credential associated with the feature of the first function relating to the service;
an acquisition module (302) able to acquire a decryption datum from the certification register (Certif) determined based on the received identifier, said decryption datum being associated with the identifier of the certification entity;
a determination module (303) able to determine the validity of the received message (Mes) comprising:
a verification module able to verify the signature and the integrity of the digital credential signed by the certification entity using the acquired decryption datum;
a comparator able to compare the validity parameter of the signed digital credential with a required value associated with the at least one feature.

According to this example, the determination module 303 is represented by a single module, but according to another example, the verification module and the comparator are two distinct modules.

Reference will now be made to [FIG. 5], which shows a transmission device 400 according to one embodiment of the invention.

Such a transmission device 400 can be implemented in a network function or application or in an elementary module of a device of a communication network, such as a 5G network. According to an alternative, the checking device can be instantiated in a communication terminal, such as a mobile terminal or access equipment for a fixed network.

For example, the transmission device 400 comprises a processing unit 430, equipped, for example, with a microprocessor μP, and driven by a computer program 410, stored in a memory 420 and implementing the transmission method according to the invention. On initialization, the code instructions of the computer program 410 are loaded, for example, into a RAM, before being executed by the processor of the processing unit 430.

Such a transmission device 400 comprises:
an acquisition module (401) able to acquire the signed digital credential from the certification entity;
an addition module (402) able to add the acquired signed digital credential to the message relating to the service to be transmitted to a second function;
a transmitter (403) able to transmit the message (Mes) including the added signed digital credential to the second function.

1. A checking method implemented by a checking device and comprising:
checking validity of a message transmitted by a first function to a second function, with the first and second functions contributing to instantiation of a service in a communication network, the checking being implemented in the second function and comprising:
receiving the message, the message comprising a signed digital credential associated with a feature of the first function relating to the service, the signed digital credential comprising an identifier of a certification register of the communication network, an identifier of a certification entity and a validity parameter of the feature of the first function relating to the service;
acquiring a decryption datum from the certification register determined based on the identifier of the received certification register, said decryption datum being associated with the identifier of the certification entity; and
determining the validity of the received message comprising:
verifying a signature and an integrity of the digital credential signed by the certification entity using the acquired decryption datum; and
comparing the validity parameter of the signed digital credential with a required value associated with the at least one feature.

2. The checking method as claimed in claim 1, wherein the first and second functions are elementary modules of a transmission device and the checking device, respectively, which are devices of the communication network, the transmission device and the checking device being the same device or distinct devices.

3. The checking method as claimed in claim 1, wherein the validity parameter of a feature is one or more parameters from among the following parameters:
a maximum validity date of the signed credential;
a non-revocation parameter of the signed digital credential;
an identifier of the feature.

4. The checking method as claimed in claim 1, wherein the decryption datum is a public decryption key associated with a private encryption key related to the certification entity.

5. The checking method as claimed in claim 1, wherein determining the validity of the datum further comprises revoking the first function in case the signature and the integrity of the signed digital credential are not verified and/or the validity parameter of the signed digital credential is not equivalent to the required value.

6. The checking method as claimed in claim 1, wherein the signed digital credential further comprises location information of a revocation register, with said revocation register being able to store validity information relating to a feature of the first function.

7. The checking method as claimed in claim 1, wherein the feature related to the service of the first function is one or more of the following features:
a security feature of the first function;
a conformity feature of the message with a data format of a specific function of the communication network;
a location feature of the first function;
a consent feature of a user of the service for using a datum relating to the user that is included in the message:
a conformity feature of the first function with a rule determined by a regulation entity of the communication network;
a feature of identifying a legal entity responsible for the first function.

8. The checking method as claimed in claim 1, further comprising transmitting the signed digital credential and an identifier of the first function to the certification register, and receiving, following this transmission, the decryption datum associated with the certification entity.

9. A transmission method implemented by a transmission device and comprising:
transmitting a message by a first function to a second function, the first and second functions contributing to instantiation of a service in a communication network, the transmitting being implemented in the first function and comprising:
acquiring a signed digital credential from a certification entity, the signed digital credential comprising an identifier of a certification register of the communication network, an identifier of the certification entity and a validity parameter of a feature of the first function relating to the service;
adding the acquired signed digital credential to a message relating to the service to be transmitted to a second function; and
transmitting the message including the added signed digital credential to the second function.

10. The transmission method as claimed in claim 9, further comprising transmitting a certification request to the certification entity requesting the certification of the feature and wherein the acquired signed digital credential includes certification information generated based on an encryption datum associated with the certification entity.

11. A checking device for checking validity of a message transmitted by a first function to a second function, with the first and second functions contributing to instantiation of a service in a communication network, the checking device instantiated in the second function and comprising:
a receiver able to receive the message, the message comprising a signed digital credential associated with a feature of the first function relating to the service, the signed digital credential comprising an identifier of a certification register of the communication network, an identifier of a certification entity and a validity parameter of the feature of the first function relating to the service;
at least one processor configured to:
acquire a decryption datum from the certification register determined based on the identifier of the received certification register, said decryption datum being associated with the identifier of the certification entity;
determine the validity of the received message comprising:
verify a signature and an integrity of the digital credential signed by the certification entity using the acquired decryption datum; and
compare the validity parameter of the signed digital credential with a required value associated with the at least one feature.

12. A transmission device for transmitting a message by a first function to a second function, with the first and second functions contributing to instantiation of a service in a communication network, the transmission device implemented in the first function and comprising:
a transmitter; and
at least one processor configured to:
acquire a signed digital credential from certification entity, the signed digital credential comprising an identifier of a certification register of the communication network, an identifier of the certification entity and a validity parameter of a feature of the first function relating to the service;
add the acquired signed digital credential to a message relating to the service to be transmitted to a second function; and
transmit the message including the added signed digital credential to the second function, using the transmitter.

13. (canceled)

14. (canceled)

15. A non-transitory computer readable medium comprising a computer program stored thereon comprising instructions for implementing a transmission method when said program is executed by a processor of a transmission device, wherein the transmission method comprises:
transmitting a message by a first function to a second function, the first and second functions contributing to instantiation of a service in a communication network, the transmitting being implemented in the first function and comprising:
acquiring a signed digital credential from a certification entity, the signed digital credential comprising an identifier of a certification register of the communication network, an identifier of the certification entity and a validity parameter of a feature of the first function relating to the service;
adding the acquired signed digital credential to a message relating to the service to be transmitted to a second function; and
transmitting the message including the added signed digital credential to the second function.
